(19) United States
(12) Patent Application Publication
(10) Pub. No.: US 2020/0132282 A1
(43) Pub. Date: Apr. 30, 2020

(54) Lamp with Stand

(71) Applicant: Verilux, Inc., Waitsfield, VT (US)

(72) Inventor: Nicholas Harmon, Waitsfield, VT (US)

(21) Appl. No.: 16/169,401

(22) Filed: Oct. 24, 2018

(51) Int. Cl. F21V 21/14; F21V 21/06; F21V 23/04; F21V 21/088; F21L 14/00

(52) U.S. Cl. CPC F21V 21/145; F21V 21/06; F21Y 2115/10; F21V 21/0885; F21L 14/00; F21V 23/0414

(57) ABSTRACT

A lamp having a light source for emitting light, a stand having a plate and a first connector, the lamp having a protrusion and a second connector, the stand being connectable to the lamp in a standing position and in a stowing position, wherein in the standing position, the first connector is connected to the second connector, and wherein in the stowing position, the plate is connected to the protrusion.

### TECHNICAL FIELD

The invention relates to a lamp, including a lamp with a stand, and a healthy lighting lamp.

### BACKGROUND

Sunlight is an essential ingredient for a healthy lifestyle, and many people do not receive enough natural light. Healthy lighting lamps mimic sunlight to enhance mood, energy, sleep, and focus. Healthy lighting lamps have been shown to help with common problems such as winter blues, sleep disorders, light deprivation, jet lag, shift work and other symptoms alleviated by exposure to healthy light.

Healthy lighting lamps are often large and bulky due to their size and shape. Since healthy lighting lamps must generally stand up during use, they either must be large enough to support themselves or include a stand. Lamps and stands may be difficult to pack or ship due to their size or shape. This frustrates users who travel with their lamps and increases shipping costs for manufacturers and distributors. Therefore, a more packable healthy lighting lamp is desirable.

In addition, healthy lighting lamps are often limited to one working intensity and color temperature. Since users benefit from being able to select their optimal intensity and/or color temperature, there is a desire for a healthy lighting device that allows such user selection.

Moreover, it is recommended that users of healthy lighting lamps do so for approximately 20 minutes. Therefore, there is a need for healthy lighting lamps that shut off automatically or alert the user when this recommended amount of time has been reached.

Finally, current healthy lighting lamps use custom light bulbs that are often short-lived and need replacement. There is a need for a longer-lasting full-spectrum light source for healthy lighting lamps.

### SUMMARY

It is an objective of the present invention to provide a more packable or shippable lamp.

It is a further object of the present invention to provide a lamp with multiple selectable and operative light intensities and color temperatures.

It is a further object of the present invention to provide a lamp with a timer and indicator.

It is a further object of the present invention to provide a lamp with a longer-lasting full-spectrum light source, such as LEDs.

### BRIEF DESCRIPTION OF THE DRAWINGS

FIG. 1 is a perspective view of the inventive lamp.

FIG. 2 is a front view of the inventive lamp.

FIG. 3 is a back perspective view of the inventive lamp.

FIG. 4 is a back view of the inventive lamp with the stand stowed.

FIG. 5 is a back view of the inventive lamp with the stand attached to the bottom of the lamp.

FIG. 6 is a perspective view of the inventive lamp.

FIG. 7 is a front view of the inventive lamp.

FIG. 8 is a back perspective view of the inventive lamp.

FIG. 9 is a back view of the inventive lamp with the stand stowed.

FIG. 10 is a back view of the inventive lamp with the stand attached to the bottom of the lamp.

FIG. 11 is a perspective view of the inventive lamp.

FIG. 12 is a front view of the inventive lamp.

FIG. 13 is a back-perspective view of the inventive lamp.

### DETAILED DESCRIPTION

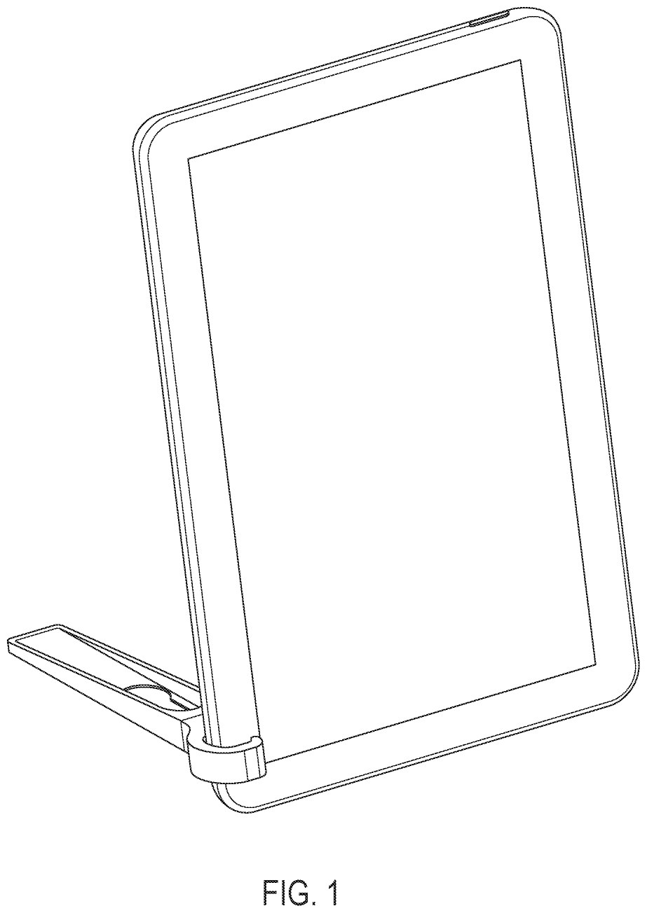

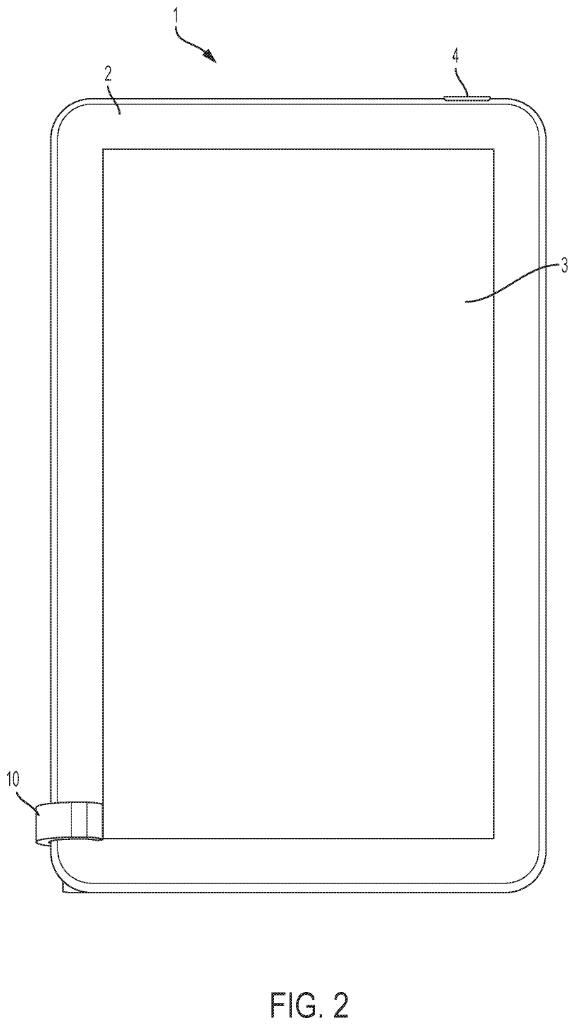

FIGS. 1 and 2 shows lamp 1, that surrounds light emitting surface 3. Stand 10 is attached to lamp 1 for holding it upright during use.

Case 2 surrounds a light emitting surface 3. Button 4 on a surface of case 2 may be used to turn lamp 1 on and off. Case 2 and stand 10 may be made from any suitable material such as a rigid plastic, a metal composite or composition, or combinations thereof. In addition, lamp 1 may comprise any finish and color desired to match an interior design of a workspace.

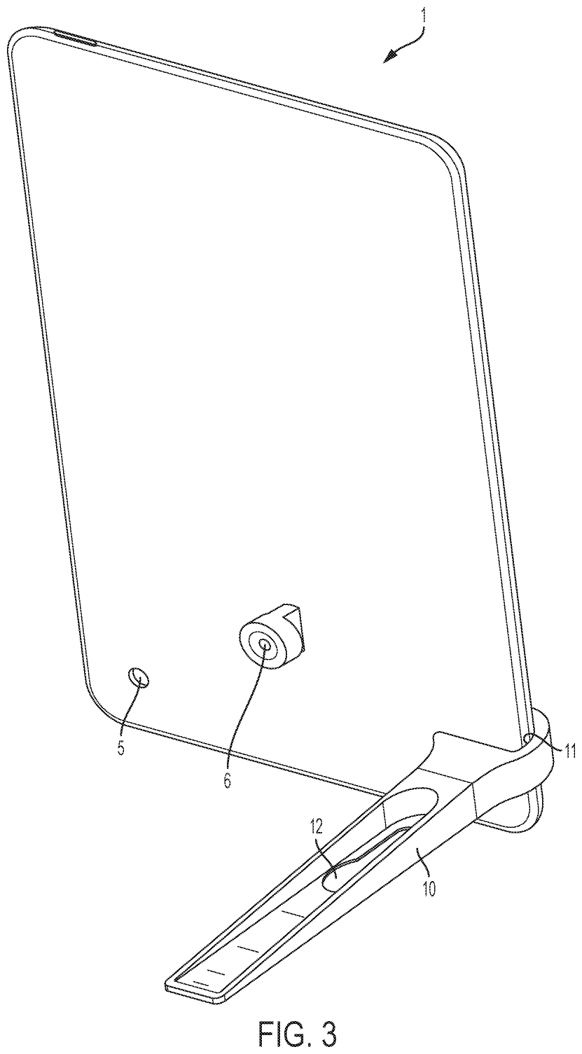

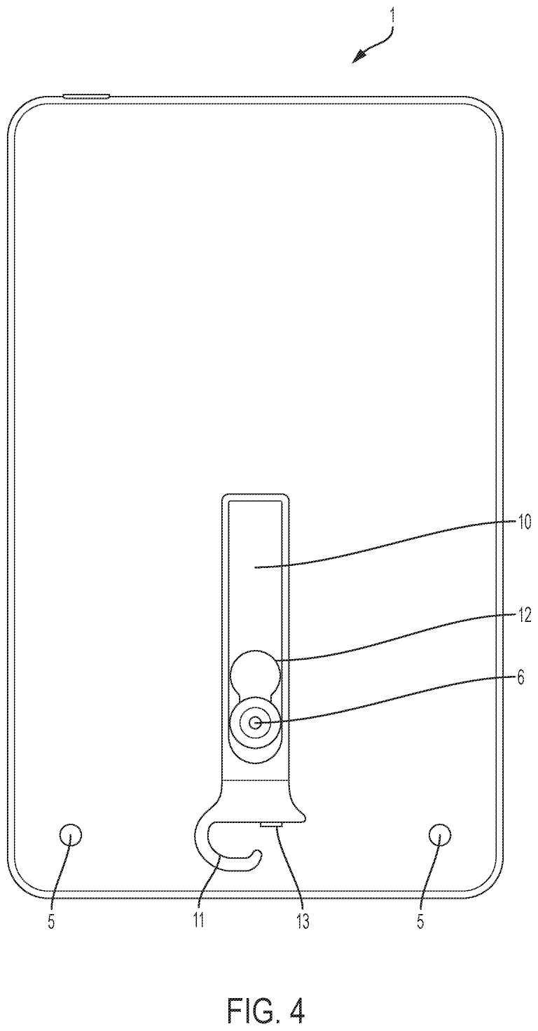

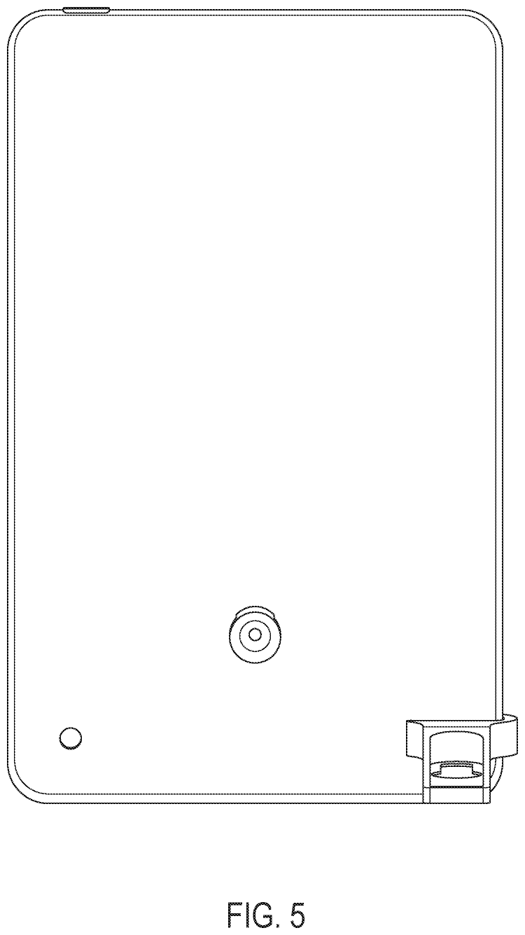

As shown in FIGS. 3-5, stand 10 has a U-shaped clip 11, which is attachable to case 2. When attached to lamp 1, a portion of stand 10, and a side of case 2 keep lamp 1 upright. U-shaped clip 11 may have a bump 13 that extends from its surface to engage with one of multiple depressions 5 in case 2. Bump 13 and depressions 5 help to ensure that U-shaped clip 11 remains in place when holding lamp 1 upright.

U-shaped clip 11 may be attached to case 2 in multiple ways. For example, as shown in FIG. 2, U-shaped clip 11 may be engaged with any depression 5 such that lamp 1 stands in a “portrait” position. Alternatively, stand 10 and U-shaped clip 11 may be positioned such that lamp 1 is in a “landscape” position, rotated approximately 90 degrees from the “portrait” position. U-shaped clip 11 may be attached such the long edge of stand 10, or the short edge of stand 10 is in contact with the surface upon which lamp 1 sits. Stand 10 and case 2 both have multiple, substantially flat sides to enable lamp 1 to sit in multiple configurations.

When lamp 1 is to be shipped, packed or otherwise stowed, stand 10 can be locked on protrusion 6, which extends from a back surface of case 2. Protrusion 6 is and cut-out portion 12 of stand 10 are sized such that they are engageable with one another, as shown in FIG. 3. Stand 10 can then be slid such that cut-out portion 12 and protrusion 6 are locked together. Protrusion 6 may also be configured to connect to a power cable.

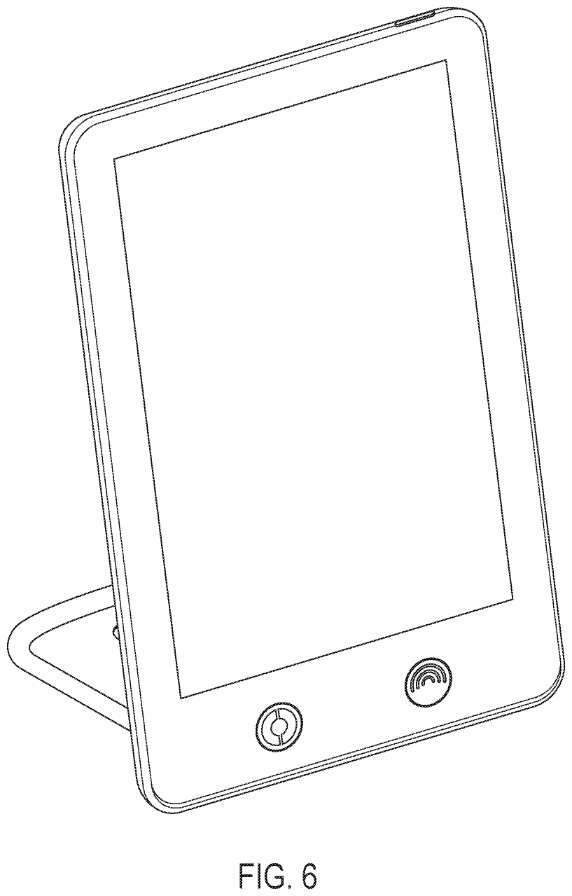

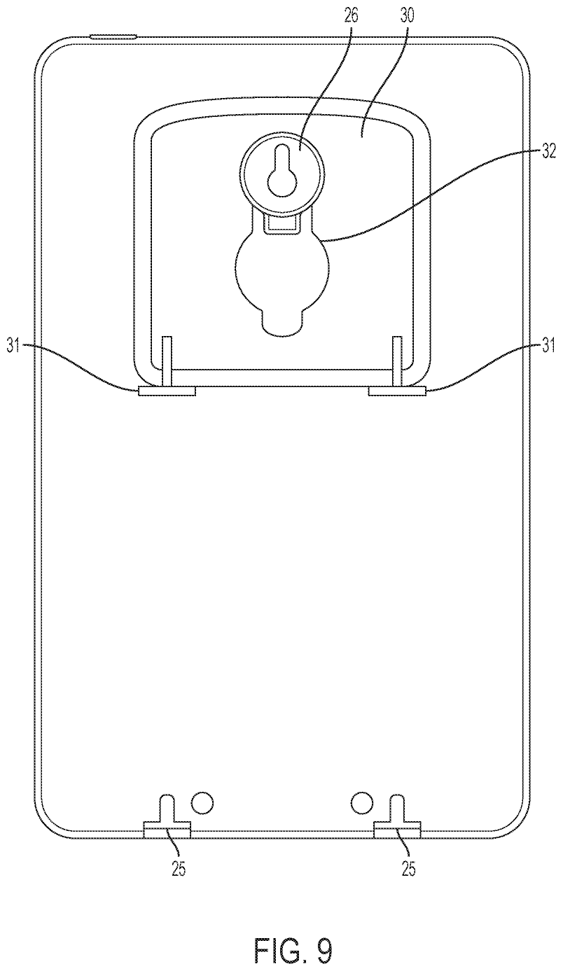

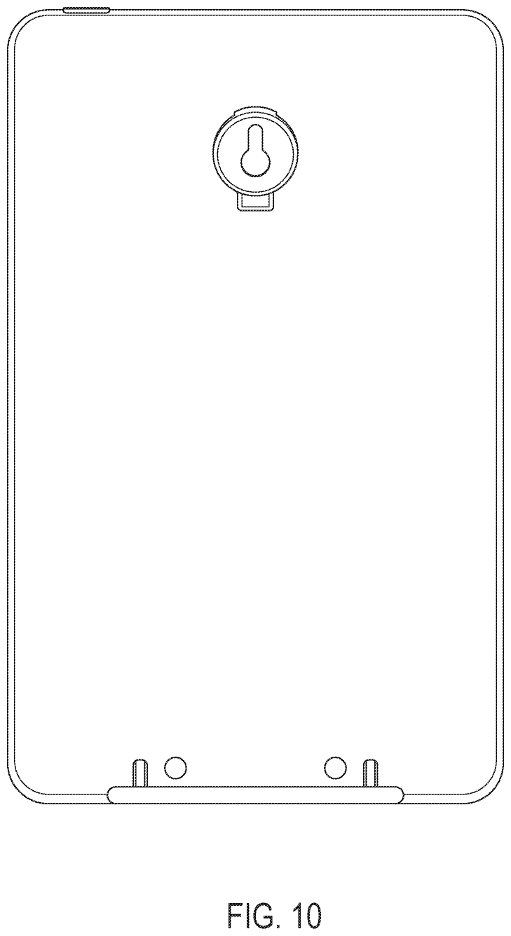

FIGS. 6-10 show lamp 21, with a case 22 that surrounds a light emitting surface 23. Lamp 21 may include a power button 24. Buttons 27 and 28 may also be provided to perform functions of lamp 21. These functions can include, but are not limited to, increasing or decreasing brightness, modifying the emitted light temperature, and setting a usage timer. When pressed, buttons 27 and 28 may cycle through predetermined settings for these functions, or modify the functions at predetermined increments. Lamp 21 may include a controller for effectuating these functions. The controller may include circuitry, including analog and digital circuitry, a computer, including a microprocessor, FGPA, embedded controller, or the like.

For example, buttons 27 or 28 may set lamp 21 to emit light at a brightness of 2,000-15,000 lux at a distance of 4-6 inches. In one preferred embodiment, buttons 27 or 28 may be pressed to cycle emitted light between 2,500, 5,000, 7,500, or 10,000 lux. Buttons 27 or 28 may also set the light temperature of the light emitted from lamp 21 between 3,000 K and 6,500 K. In one preferred embodiment, buttons 27 or 28 may cycle light temperature levels between 3,000 K and 5,000 K in 500 K increments. Buttons 27 or 28 may also set a usage timer for 5, 10, 20, or 30 minutes, after which the lamp may notify the user of the elapsed time, shut off, or both. In one preferred embodiment, the usage time is set for 20 minutes. The values for each of these functions are exemplary, as buttons 27 and 28 may be programmed to set any value associated with any function.

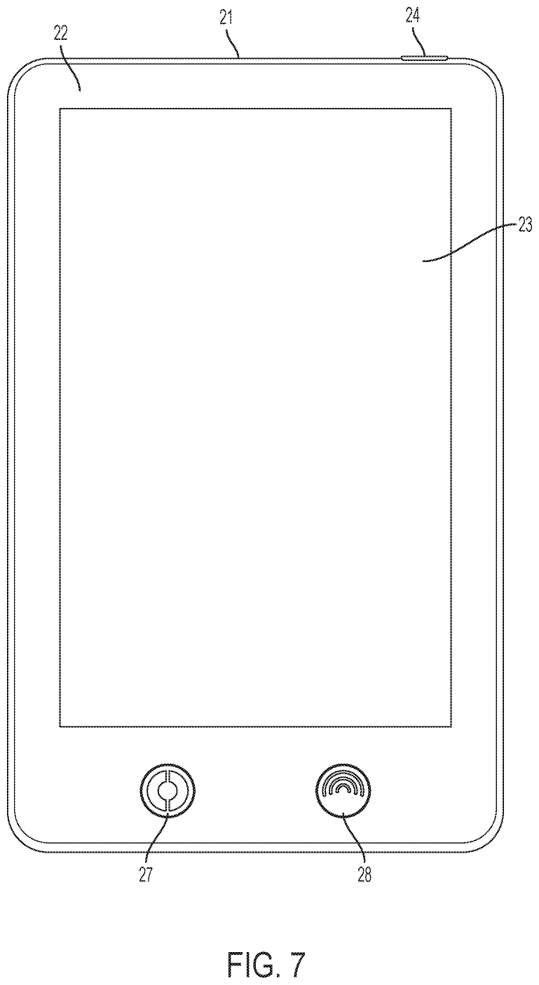

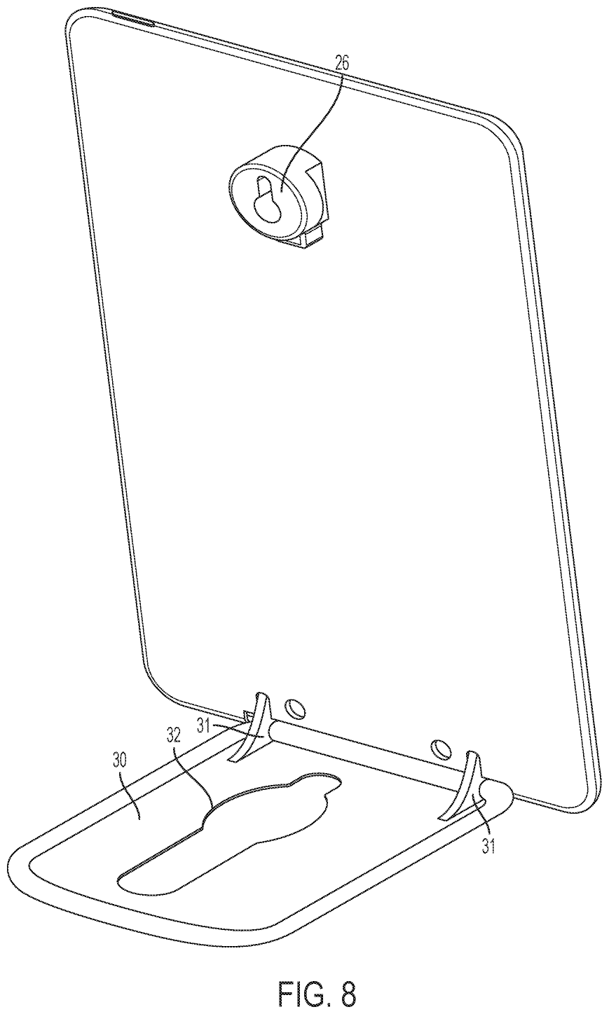

So that lamp 21 may stand upright during use, stand 30 is attachable to lamp 21, as shown in FIGS. 8-10. Stand 30 has extensions 31, which are attachable to case 22 via receptors 25. When lamp 21 is to be shipped, packed or otherwise stowed, stand 30 can be locked on protrusion 26, which extends from a back surface of case 22. Protrusion 26 is and cut-out portion 22 of stand 30 are sized such that they are engageable with one another, as shown in FIG. 7. Stand 30 can then be slid such that cut-out portion 22 and protrusion 26 are locked together. Protrusion 26 may also be configured to connect to a power cable.

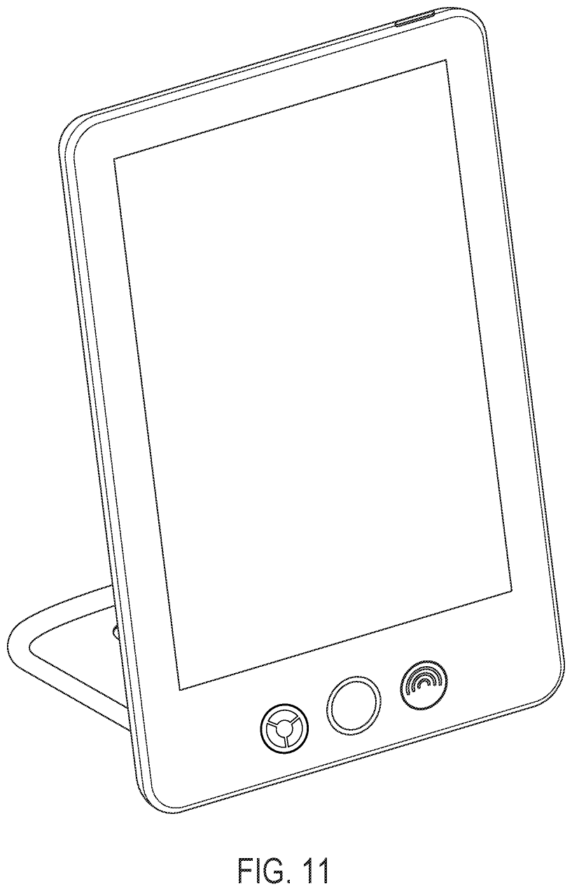

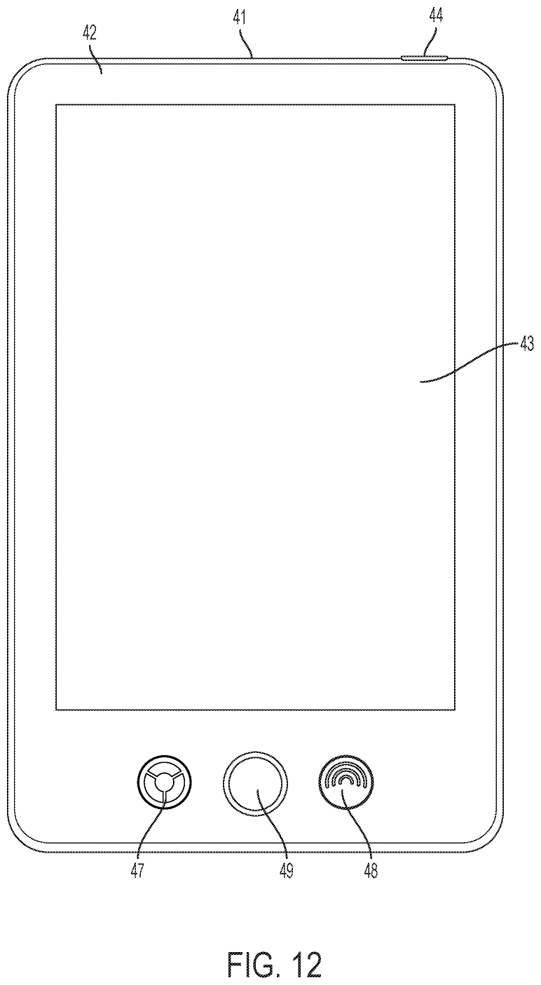

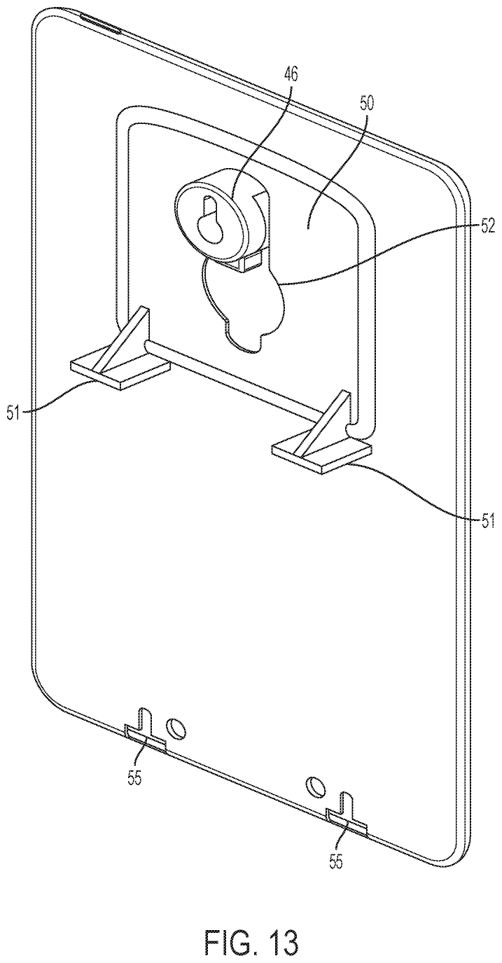

FIGS. 11-13 show lamp 41, with a case 42 that surrounds a light emitting surface 43. Lamp 41 may include a power button 44. Buttons 47, 48, and 49 may also be provided to perform functions of lamp 41. These functions can include, but are not limited to, increasing or decreasing brightness, modifying the emitted light temperature, and setting a usage timer. Buttons 47, 48, and 49 may cycle through predetermined settings for these functions or modify the functions at predetermined increments. The functions of the lamp may be programmable. Lamp 41 may include a controller for effectuating these functions. The controller may include circuitry, including analog and digital circuitry, a computer, including a microprocessor, FGPA, embedded controller, or the like.

For example, buttons 47, 48, or 49 may set lamp 21 to emit light at a brightness of 2,000-15,000 lux at a distance of 4-6 inches. In one preferred embodiment, buttons 47, 48, or 49 may be pressed to cycle emitted light between 2,500, 5,000, 7,500, or 10,000 lux. Buttons 47, 48, or 49 may also set the light temperature of the light emitted from lamp 21 between 3,000 K and 6,500 K. In one preferred embodiment, buttons 47, 48, or 49 may cycle light temperature levels between 3,000 K and 5,000 K in 500 K increments. Buttons 47, 48, or 49 may also set a usage timer for 5, 10, 20, or 30 minutes, after which the lamp may notify the user of the elapsed time, shut off, or both. In one preferred embodiment, the usage time is set for 20 minutes. The values for each of these functions are exemplary, as buttons 47, 48, or 49 may be programmed to set any value associated with any function.

Button 49 may also include an indicator showing a progression of a function. The indicator may be a circular ring that is used to indicate the elapsed or remaining amount of time on a usage timer, the brightness level, or the light temperature. For example, circular ring 49 may show a 20-minute usage timer by illuminating neighboring portions of the circular ring after two-minute increments.

So that lamp 41 may stand upright during use, stand 50 is attachable to lamp 41, as shown in FIG. 11. Stand 50 has extensions 51, which are attachable to case 42 via receptors 45. When lamp 41 is to be shipped, packed or otherwise stowed, stand 50 can be locked on protrusion 46, which extends from a back surface of case 42. Protrusion 46 is and cut-out portion 42 of stand 50 are sized such that they are engageable with one another, as shown in FIG. 7. Stand 50 can then be slid such that cut-out portion 42 and protrusion 46 are locked together. Protrusion 46 may also be configured to connect to a power cable.

Lamps 1, 21, or 41 may use various types of light sources, including fluorescent, compact fluorescent, neodymium, and LED. LEDs may include various types of LEDs, including through-hole LEDs, SMD LEDs, bi-color LEDs, RGB LEDs, High-Power LEDs, and others. Light sources of different color temperatures may be used in order to dynamically change the output color temperature. For example, by selectively mixing an LED with a cool temperature of light and an LED with a warm temperature of light, any temperature of light may be emitted by lamps 1, 21, and 41. Buttons 27, 28, 47, 48, and 49 may control the temperature of the emitted light in this manner.

Lamps 1, 21, or 41 may include a flush lens or a recessed lens. Lamps 1, 21, or 41 may also be edge-lit or back-lit. Back-lit lamps allow for the use of more LEDs (or other light sources) to control the output characteristics of the light. Edge-lit lamps provide the benefit of creating a more uniform and aesthetic light output.

Lamps 1, 21, or 41 may also include a wall-mount feature. The wall-mount feature may allow a user to quickly and easily remove it from the wall for travel purposes.

Although the invention has been described with reference to a particular arrangement of parts, features and the like, these are not intended to exhaust all possible arrangements or features, and indeed many other modifications and variations will be ascertainable to those of skill in the art.

1. A lamp comprising:
a light source for emitting light;
a stand having a plate and a first connector;
the lamp having a protrusion and a second connector;
the stand being connectable to the lamp in a standing position and in a stowing position;
wherein in the standing position, the first connector is connected to the second connector and the plate is disconnected from the protrusion; and
wherein in the stowing position, the plate is connected to the protrusion and the first connector is disconnected from the second connector.

2. The lamp of claim 1, wherein the first connector is a clip and the second connector is a recess.

3. The lamp of claim 1, wherein the lamp has a third connector, wherein the stand is connectable to the lamp is a second standing position in which the first connector is connected to the third connector.

4. The lamp of claim 1, wherein the plate has a cutout for connecting to the protrusion.

5. The lamp of claim 1, wherein the protrusion has an opening for inserting a cable.

6. The lamp of claim 1, wherein the lamp has a button for controlling a function of the lamp.

7. The lamp of claim 5, wherein the function is a timer.

8. The lamp of claim 5, wherein the function modifies a color temperature of the emitted light.

9. The lamp of claim 5, wherein the function modifies a light intensity of the emitted light.

10. The lamp of claim 5, wherein the lamp has an indicator for displaying a metric associated with the function of the lamp.

11. The lamp of claim 1, wherein the light source is a LED.

12. The lamp of claim 1, wherein the lamp is edge lit.

13. A system comprising:
a stand having a first connector and a third connector;
a panel having a second connector and a fourth connector;
the stand being connectable to the panel in a standing position and a stowing position;
wherein the fourth connection is a protrusion that extends from a surface of the panel;
wherein in the standing position, first connector is connected to the second connector and the third connector is disconnected from the fourth connector; and
wherein in the stowing position, the third connector is connected to the fourth connector and the first connector is disconnected from the second connector.

14. The system of claim 13, wherein the first connector is a clip and the second connector is a recess, and wherein the third connector is a plate.
